(19) United States
(12) Patent Application Publication
(10) Pub. No.: US 2013/0010928 A1
(43) Pub. Date: Jan. 10, 2013

(54) SYSTEM FOR WIRELESS COMMUNICATION WITH MULTIPLE ANTENNAS IN A MEDICAL IMAGING SYSTEM

(75) Inventors: Jeremy Patrick Hannon, Milwaukee, WI (US); Luke Gerard Beno, Brookfield, WI (US)

(73) Assignee: General Electric Company, Schenectady, NY (US)

(21) Appl. No.: 13/178,689

(22) Filed: Jul. 8, 2011

(51) Int. Cl. H05G 1/64

(52) U.S. Cl. 378/98

(57) ABSTRACT

A medical imaging system includes a mobile imager. The mobile imager includes a source of X-ray radiation and at least two antennas for wireless communication. The medical imaging system also includes a digital X-ray detector configured to receive X-ray radiation from the source, wherein the digital X-ray detector includes at least one antenna to communicate wirelessly with the mobile imager.

### BACKGROUND OF THE INVENTION

The subject matter disclosed herein relates to medical imaging systems and more particularly to a system for wireless communication within the medical imaging systems.

A number of medical imaging systems of various designs are known and are presently in use. Examples of medical imaging systems include basic X-ray systems, computed tomography systems, positron emission tomography systems, magnetic resonance imaging systems, fluoroscopy systems, and ultrasound imaging systems. Through the use of medical imaging systems, medical professionals, such as physicians, can produce detailed images of internal tissues, anatomies and organs of patients, thereby mitigating the need for invasive exploratory procedures and providing valuable tools for identifying and diagnosing disease and for verifying wellness.

Often components of these medical imaging systems communicate wirelessly. For example, a digital X-ray detector may communicate wirelessly with components of an image data acquisition or processing system (e.g., mobile or fixed system) of the medical imaging system to transfer large amounts of data (e.g., exposure image). However, configuring the wireless communication between these components of the medical imaging systems may involve costly and complex wireless setups. Further, in order to comply with regulatory measures, these complex wireless setups may sacrifice wireless signal quality (e.g., signal gain and signal reception) impeding the rate of data transfer between components of the medical imaging systems.

There is a need, therefore, for improved approaches to improve the signal quality for the wireless communication between components of the medical imaging systems. There is a particular need for a simple and cost-effective wireless communication setup between components of the medical imaging systems that improves signal quality via, for example, increased signal gain and increased signal reception.

### BRIEF DESCRIPTION OF THE INVENTION

In accordance with certain aspects of the present techniques, a medical imaging system includes a mobile imager. The mobile imager includes a source of X-ray radiation and at least two antennas for wireless communication. The medical imaging system also includes a digital X-ray detector configured to receive X-ray radiation from the source, wherein the digital X-ray detector includes at least one antenna to communicate wirelessly with the mobile imager.

In accordance with another aspect, a medical imaging system includes an imager system. The imager system includes a source of X-ray radiation and at least two antennas for wireless communication. The medical imaging system also includes a digital X-ray detector configured to receive X-ray radiation from the source, wherein the digital X-ray detector includes at least one antenna to communicate wirelessly with the imager system.

In accordance with a further aspect, a medical imaging system includes an imager system. The imager system includes at least two ultra wideband antennas for wireless communication with a different component of the medical imaging system. The different component includes at least one antenna to communicate wirelessly with the imager system. Also, the imager system is configured to wirelessly communicate with the different component via an antenna with the strongest signal strength among the at least two antennas.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is perspective view of a fixed X-ray system, equipped in accordance with aspects of the present disclosure;

FIG. 2 is a perspective view of a mobile X-ray system, equipped in accordance with aspects of the present disclosure;

FIG. 3 is a diagrammatical overview of the X-ray systems in FIGS. 1 and 2;

FIG. 4 is a diagrammatical overview of an ultrasound system, equipped in accordance with aspects of the present disclosure;

FIG. 5 is a schematic top view of coverage for wireless communication within a fixed X-ray system, in accordance with aspects of the present disclosure; and

FIG. 6 is a schematic top view of coverage for wireless communication within a mobile X-ray system, in accordance with aspects of the present disclosure.

### DETAILED DESCRIPTION OF THE INVENTION

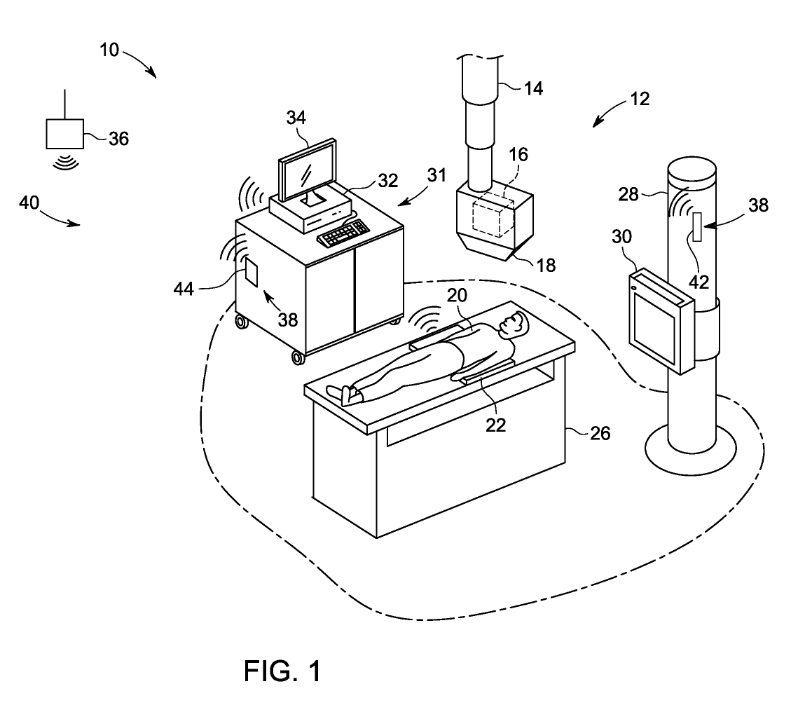

Referring generally to FIG. 1, a medical imaging system, in particular an X-ray system is represented and referenced generally by reference numeral 10. In the illustrated embodiment, the X-ray system 10 is a digital X-ray system. The X-ray system 10 is designed both to acquire original image data and to process the image data for display in accordance with the present technique. As discussed below, the X-ray system 10 includes a wireless communication system using ultra wideband (UWB) communication configured to improve the signal quality and to increase the data rate exchange between components of the X-ray system 10 (e.g., imager system and detector). Besides radiological based systems, the wireless communication system may be used in other types of medical imaging (e.g., ultrasound imaging system).

In the embodiment illustrated in FIG. 1, the X-ray system 10 includes an imager system 12. The imager system 12 includes an overhead tube support arm 14 for positioning a radiation source 16, such as an X-ray tube, and a collimator 18 with respect to a patient 20 and a portable digital X-ray detector 22. In one embodiment, the imager system 12 may be used in consort with one or both of a patient table 26 and a wall stand 28 to facilitate image acquisition. Particularly, the table 26 and the wall stand 28 may be configured to receive the detector 22. For instance, the detector 22 may be placed on an upper, lower, or intermediate surface of the table 26, and the patient 20 (more specifically, an anatomy of interest of the patient 20) may be positioned on the table 26 between the detector 22 and the radiation source 16. Also, the wall stand 28 may include a receiving structure 30 also adapted to receive the detector 22, and the patient 20 may be positioned adjacent the wall stand 28 to enable the image data to be acquired via the detector 22. The receiving structure 30 may be moved vertically along the wall stand 28.

Also depicted in FIG. 1, the imager system 12 includes a systems cabinet 31 that includes a workstation 32 and display 34. In one embodiment, the workstation 32 may include or provide the functionality of the imager system 12 such that a user, by interacting with the workstation 32 may control operation of the source 16 and detector 22. The detector 22 may be in communication with the workstation 34 as described below. The workstation 34 may house systems electronic circuitry that acquires image data from the detector 22 and that, where properly equipped (e.g., when the workstation 34 includes processing circuitry), may process the data to form desired images. In addition, the systems electronic circuitry both provides and controls power to the X-ray source 16. The workstation 32 may include buttons, switches, or the like to facilitate operation of the X-ray source 16 and detector 22. In one embodiment, the workstation 32 may be configured to function as a server of instructions and/or content on a network 36 of the medical facility, such as a hospital information system (HIS), a radiology information system (RIS), and/or picture archiving communication system (PACS). In certain embodiments, the workstation 32 and/or detector 22 may wirelessly communicate with the network 36.

Components of the imager system 12 and the detector 22 are configured to communicate wirelessly. In particular, the imager system 12 and the detector 22 are configured to communicate by utilizing a UWB communication standard in accordance with one or more of the following standards: ECMA-368, ECMA-369, ETSI TS 102 455, ISO/IEC 26907:2007, ISO/IEC 26908:2007, or any other standard related to UWB communication. The UWB wireless communication in the X-ray system 10 is configured to enable a higher rate of data exchange between the detector 22 and the imager system 12, to increase signal gain, and to increase wireless reception. The imager system 12 includes multiple antennas 38 to facilitate wireless communication between the detector 22 and the workstation 32 or another component of the imager system 12. The antennas 38 may be disposed on components of the imager system 12 (e.g., wall stand 28 and adjacent workstation 32). Alternatively, the antennas 38 may be located throughout a room 40 (e.g., wall or ceiling) where the imager system 12 is located. At least two of the antennas 38 (e.g., antennas 42 and 44) include UWB antennas. The UWB antennas 42 and 44 are located on components of the imager system 12 and/or throughout the room 40 to provide complementary antenna patterns (e.g., to provide coverage to most of the room 40) and to enable communication between the detector 22 and the UWB antenna 42 or 44 with the strongest signal strength. For example, the imager system 12 may utilize UWB antenna 44 when the detector 22 is utilized on the table 26 and utilize UWB antenna 42 when the detector 22 is utilized in conjunction with the wall stand 28 and receiving structure 30, or vice versa, depending on the signal strength of the antennas 42 and 44 relative to the detector 22. In addition, placement of the UWB antennas 42 and 44 may take into account factors such as antenna polarization, proximity to large metal objects or reflectors, cable routing, and human body loading.

The detector 22 may only wirelessly communicate with a single UWB antenna 42 or 44 at a time. To ensure communication between the detector 22 and a single UWB antenna 42 or 44, the UWB antennas 42 and 44 may be set to different channels. Alternatively, the UWB antennas 42 and 44 may be selectively turned on or off depending on the signal strength of the antennas 42 and 44 relative to the detector as described in greater detail below.

In some embodiments, at least two of the UWB antennas 42 and 44 are configured to function as both a transmitter and receiver. For example, at least two of the UWB antennas 42 and 44 may include omnidirectional antennas. Omnidirectional antennas radiate power uniformly in all directions in one plane; however, the radiated power decreases with elevation angle above or below the plane, dropping to zero near an axis of the antenna. In particular, the omnidirectional antenna forms a donut-shaped radiation pattern.

In certain embodiments, at least one of the UWB antennas 42 or 44 is configured to solely function as a transmitter, while at least one of the other UWB antennas 42 or 44 is configured to function solely as a receiver. The UWB antenna 42 or 44 functioning as a transmitter may include a low gain antenna (e.g., omnidirectional antenna) to adhere to power output limits set by regulatory agencies, while the UWB antenna 42 or 44 functioning as a receiver may include a high gain antenna (e.g., directional sector antenna) to increase reception sensitivity. Thus, in some embodiments, the at least two UWB antennas 42 and 44 may include at least one omnidirectional antenna and at least one directional sector antenna. Directional sector antennas radiate greater power in one or more directions (e.g., a sector-shaped radiation pattern). Besides the at least two UWB antennas 42 and 44, additional antennas 38 within the imager system 12 may utilize any suitable wireless communication protocol, such as an IEEE 802.15.4 protocol, an UWB communication standard, a Bluetooth communication standard, or any IEEE 802.11 communication standard.

In one embodiment, the imager system 12 may be a stationary system disposed in a fixed X-ray imaging room 40, such as that generally depicted in and described above with respect to FIG. 1. It will be appreciated, however, that the presently disclosed techniques may also be employed with other imaging systems, including mobile X-ray units and systems, in other embodiments.

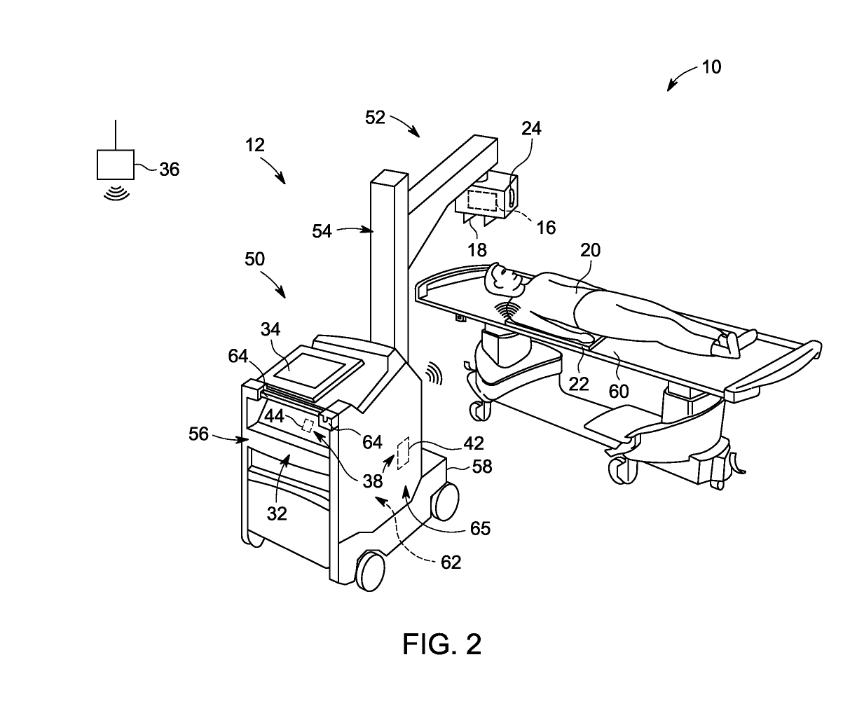

For instance, as illustrated in the medical imaging system 10 (e.g., X-ray system) of FIG. 2, the imager system 12 may be moved to a patient recovery room, an emergency room, a surgical room, or any other space to enable imaging of the patient 20 without requiring transport of the patient 20 to a dedicated (i.e., fixed) X-ray imaging room. The X-ray system 10 includes a mobile imager or mobile X-ray base station 50 and a portable digital X-ray detector 22. As above, the illustrated X-ray system 10 is a digital X-ray system. In one embodiment, a support arm 52 may be vertically moved along a support column 54 to facilitate positioning of the radiation source 16 and collimator 18 with respect to the patient 20. Further, one or both of the support arm 52 and support column 54 may also be configured to allow rotation of the radiation source 16 about an axis. In addition, the X-ray base station 50 has a wheeled base 58 for movement of the station 50.

The patient 20 may be located on a bed 60 (or gurney, table or any other support) between the X-ray source 24 and the detector 22 and subjected to X-rays that pass through the patient 20. During an imaging sequence using the digital X-ray system 10, the detector 22 receives X-rays that pass through the patient 20 and transmits imaging data to a base unit 56. The detector 22 is in wireless communication with the base unit 56. The base unit 56 houses systems electronic circuitry 62 that acquires image data from the detector 22 and that, where properly equipped, may process the data to form desired images. In addition, the systems electronic circuitry 62 both provides and controls power to the X-ray source 16 and the wheeled base 58. The base unit 56 also has the operator workstation 32 and display 34 that enables the user to operate the X-ray system 10. The operator workstation 32 may include buttons, switches, or the like to facilitate operation of the X-ray source 16 and detector 22. In one embodiment, the workstation 32 may be configured to function as a server of instructions and/or content on the network 36 of the medical facility, such as HIS, RIS, and/or PACS. In certain embodiments, the workstation 32 and/or detector 22 may wirelessly communicate with the network 36.

Similar to the X-ray system 10 in FIG. 1, components of the imager system 12 (e.g., base unit 56) and the detector 22 are configured to communicate wirelessly. The imager system 12 and the detector 22 are configured to communicate by utilizing a UWB communication standard as described above. The UWB wireless communication in the X-ray system 10 is configured to enable a higher rate of data exchange between the detector 22 and the imager system 12, to increase signal gain, and to increase wireless reception. The imager system 12 includes multiple antennas 38 to facilitate wireless communication between the detector 22 and the workstation 32 or another component of the imager system 12. The antennas 38 may be located within the base unit 56 of the mobile X-ray base station (e.g., antennas 42 and 44). Alternatively, the antennas 38 may be located within or on the support arm 52, support column 54, and/or other component of the mobile X-ray base station 50. At least two of the antennas 38 (e.g., antennas 42 and 44) include UWB antennas. The UWB antennas 42 and 44 are positioned within the base unit 56 of the mobile X-ray base station 50 to avoid shielding of wireless signals transmitted and received by the UWB antennas 42 and 44. In particular, the UWB antennas 42 and 44 are located within the base unit 56 of the X-ray base station 50 to avoid coverage of the antennas 42 and 44 by metal that shields the transmittal and reception of wireless signals. For example, the UWB antennas 42 and 44 may be located within the base unit 56 under the display 34 near a handle 64 of the base unit 56, near a storage tray, and/or near a bottom 65 of the base unit 56 near the support column 54. In certain embodiments, at least two UWB antennas are located on opposite sides of the base unit 56 of the X-ray base station 50.

The UWB antennas 42 and 44 are located within the imager system 12 to provide complementary antenna patterns (e.g., to provide at least 270 degrees of coverage around the X-ray base station 50) and to enable communication between the detector 22 and the UWB antenna 42 or 44 with the strongest signal strength. For example, the imager system 12 may utilize the UWB antenna 42 and 44 closest to the patient 20 (e.g., antenna 42) depending on the signal strength of the antennas 42 and 44 relative to the detector 22. In addition, placement of the UWB antennas 42 and 44 may take into account factors such as antenna polarization, proximity to large metal objects or reflectors, cable routing, human body loading, and dynamic positioning as the imager system 12 moves around.

As mentioned above, the detector 22 may only wirelessly communicate with a single UWB antenna 42 or 44 at a time. To ensure communication between the detector 22 and a single UWB antenna 42 or 44, the UWB antennas 42 and 44 may be set to different channels. Alternatively, the UWB antennas 42 and 44 may be selectively turned on or off depending on the signal strength of the antennas 42 and 44 relative to the detector as described in greater detail below. In addition, the UWB antennas 42 and 44 may be as configured as described above (e.g., omnidirectional antennas, directional sector antennas, transmitter, receiver, etc.). Besides the at least two UWB antennas 42 and 44, additional antennas 38 within the imager system 12 may utilize any suitable wireless communication protocol, such as an IEEE 802.15.4 protocol, an UWB communication standard, a Bluetooth communication standard, or any IEEE 802.11 communication standard.

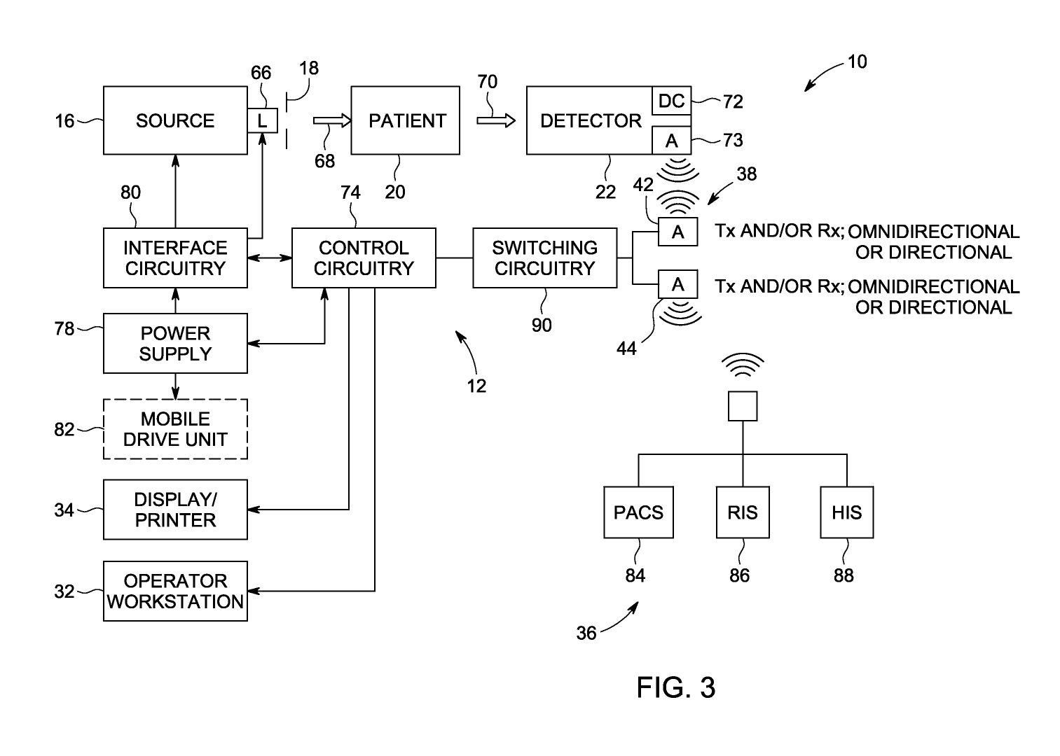

FIG. 3 illustrates diagrammatically the X-ray systems 10 described in FIGS. 1 and 2. As illustrated in FIG. 3, the X-ray system 10 includes the source of X-ray radiation 16 positioned adjacent to the collimator 18. A light source 66, also known as a collimator light, is positioned between the X-ray source 16 and the collimator 18. The collimator 18 permits a stream of radiation 68 or light to be directed to a specific region in which an object or subject, such as the patient 20, is positioned. A portion 70 of the radiation passes through or around the subject and impacts the digital X-ray detector 22. As will be appreciated by those skilled in the art, the detector 22 in digital X-ray systems 10 converts the X-ray photons received on its surface to lower energy photons, and subsequently to electric signals, which are acquired and processed to reconstruct an image of the features within the subject. The collimator light 66 in the collimator 18 directs light onto the same area where the X-ray photons will pass and can be used to position the patient 20 before exposure.

The digital X-ray detector 22 is coupled to a detector controller 72 which commands acquisition of the signals generated in the detector 22. The detector controller 72 may also execute various signal processing and filtration functions, such as for initial adjustment of dynamic ranges, interleaving of digital image data, and so forth. The detector controller 72 is responsive to signals received by at least one antenna 73 of the detector 22 from control circuitry 74. In particular, the control circuitry 74 communicated signals wirelessly using the UWB communication standard as described above via the antenna 38 with the strongest signal strength (e.g., UWB antenna 42 or 44). In certain embodiments, the detector 22 includes more than one antenna 73 to communicate with the imager system 12. In general, the control circuitry 74 commands operations of the imager system 12 to execute examination protocols and to process acquired image data. In the present context, the control circuitry 74 also includes signal processing circuitry, typically based upon a programmed general purpose or application-specific digital computer; and associated devices, such as optical memory devices, magnetic memory devices, or solid-state memory devices, for storing programs and routines executed by a processor of the computer to carry out various functionalities, as well as for storing configuration parameters and image data; interface circuits; and so forth.

In the digital X-ray systems 10, the radiation source 16 is controlled by the control circuitry 74 which controls signals for examination sequences. For example, the control circuitry 74 can inhibit the operation of the radiation source 16 if the correct examination conditions are not in place. In addition, the control circuitry 74 controls a power supply 78 which supplies power to the radiation source 16, light source 66, as well the control circuitry 74. Interface circuitry 80 facilitates the provision of power to the radiation source 16, light source 66, and control circuitry 74. The power supply 78 also provides power to a mobile drive unit 82 (in mobile X-ray systems) to drive the movement of the wheeled base 58 of the X-ray base station 50.

In the embodiment illustrated in FIG. 3, the control circuitry 74 is linked to at least one output device, such as the display or printer 34. The output device may include standard or special purpose computer monitors and associated processing circuitry. One or more operator workstations 32 may be further linked in the system for outputting system parameters, requesting examinations, viewing images, and so forth. In general, displays, printers, workstations, and similar devices supplied within the system may be local to the imaging components, or may be remote from these components, such as elsewhere within an institution or hospital, or in an entirely different location, linked to the imager system 12 via one or more configurable networks, such as the Internet, virtual private networks, and so forth. For example, in one embodiment, the workstation 32 may be configured to function as a server of instructions and/or content on the network 36 of the medical facility, such as PACS 84, RIS 86, and/or HIS 88. In certain embodiments, the workstation 32 and/or detector 22 may wirelessly communicate with the network 36.

Further, in certain embodiments, the control circuitry 74 is linked to switching circuitry 90. The switching circuitry 90 is configured to switch to UWB antenna 42 or 44 with the strongest signal strength among the at least two UWB antennas 42 and 44 to wirelessly communicate with the detector 22. In certain embodiments, the control circuitry 74 may be configured to control the switching circuitry 90 to switch between the UWB antennas 42 and 44, for example, in a slow roaming application. Alternatively, the switching circuitry 90 may be configured to control switching between the UWB antennas 42 and 44 independent of the control circuitry 74. All of the UWB antenna 42 and 44 could be coupled to the switching circuitry 90 and/or control circuitry 74 via a single cable (e.g., single USB cable). The switching circuitry 90 may include hardware switches to switch between the UWB antennas. In certain embodiments, the switching circuitry 90 may include a single physical layer (PHY) chip. Alternatively, the switching circuitry 90 may include multiple PHY chips connected to a single media access control (MAC) chip. As another alternative, the switching circuitry may include a field-programmable gate array (FPGA) with multiple MAC chips, where each MAC chip communicates with each PHY chip. Alternatively, the control circuitry 74 could be connected to multiple PHY chips via a different cable (e.g., USB or Ethernet cable) per PHY chip, which limits the length of the RF signal between antenna and PHY chip while allowing the PHY chips to be placed meters from each other via the digital communication cable.

As mentioned above, the detector 22 may only wirelessly communicate with a single UWB antenna 42 or 44 at a time. To ensure communication between the detector 22 and a single UWB antenna 42 or 44, the UWB antennas 42 and 44 may be set to different channels. Alternatively, the UWB antennas 42 and 44 may be selectively turned on or off depending on the signal strength of the antennas 42 and 44 relative to the detector 22.

In some embodiments, at least two of the UWB antennas 42 and 44 are configured to function as both a transmitter (Tx) and receiver (Rx). For example, at least two of the UWB antennas 42 and 44 may include omnidirectional antennas. Omnidirectional antennas radiate power uniformly in all directions in one plane; however, the radiated power decreases with elevation angle above or below the plane, dropping to zero near an axis of the antenna. In particular, the omnidirectional antenna forms a donut-shaped radiation pattern.

In certain embodiments, at least one of the UWB antennas 42 or 44 is configured to solely function as a transmitter, while at least one of the other UWB antennas 42 or 44 is configured to function solely as a receiver. The UWB antenna 42 or 44 functioning as a transmitter may include a low gain antenna (e.g., omnidirectional antenna) to adhere to power output limits set by regulatory agencies, while the UWB antenna 42 or 44 functioning as a receiver may include a high gain antenna (e.g., directional sector antenna) to increase reception sensitivity. Thus, in some embodiments, the at least two UWB antennas 42 and 44 may include at least one omnidirectional antenna and at least one directional sector antenna. Directional sector antennas radiate greater power in one or more directions (e.g., a sector-shaped radiation pattern). As mentioned above, besides the at least two UWB antennas 42 and 44, additional antennas 38 within the imager system 12 may utilize any suitable wireless communication protocol, such as an IEEE 802.15.4 protocol, an UWB communication standard, a Bluetooth communication standard, or any IEEE 802.11 communication standard.

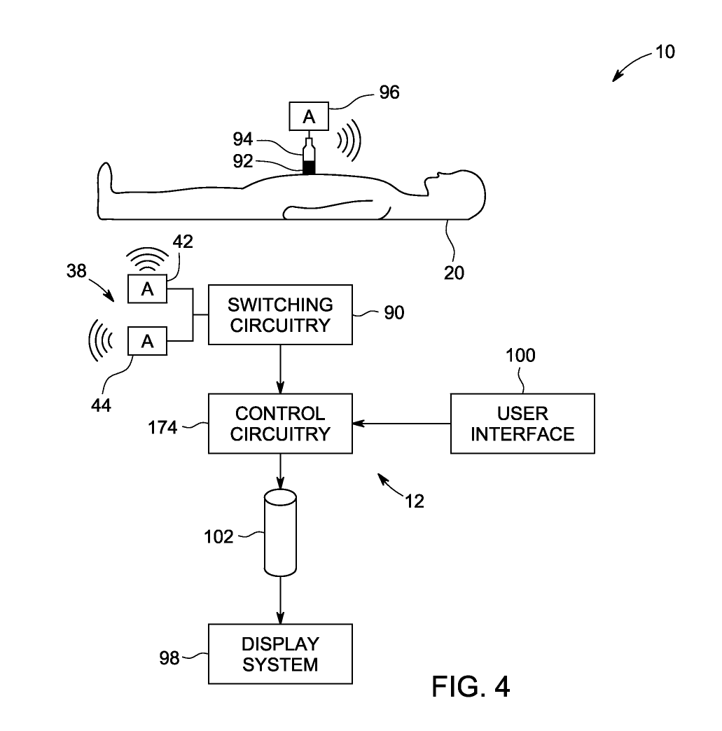

As mentioned above, besides radiological based systems, the wireless communication system may be used in other types of medical imaging. FIG. 4 illustrates a medical imaging system 10, in particular, an ultrasound system for acquiring and processing ultrasonic images. The wireless communication system using ultra wideband (UWB) communication is configured to improve the signal quality and to increase the data rate exchange between components of the ultrasound system 10. The ultrasound system 10 includes a transmitter that drives one or more arrays of elements 92 (e.g., piezoelectric crystals) within or formed as part of a probe 94 to emit pulsed ultrasonic signals into a body or volume of the patient 20. A variety of geometries may be used and one or more transducers may be provided as part of the probe 16. The pulsed ultrasonic signals are back-scattered from density interfaces and/or structures, for example, in a body, like blood cells or muscular tissue, to produce echoes that return to the elements 92. The echoes are received by a receiver and provided to a beam former. The beam former performs beamforming on the received echoes and outputs an RF signal. The RF signal is then processed by an RF processor. The RF processor may include a complex demodulator that demodulates the RF signal to form IQ data pairs representative of the echo signals. The RF or IQ signal data then may be routed directly to an RF/IQ buffer for storage (e.g., temporary storage).

The probe 94 is configured to wirelessly communicate with the imager system 12 of the ultrasound system 10 utilizing the UWB communication standard as described above. In particular, the probe 94 includes one or more antennas 96 to communicate with the imager system. The imager system 12 includes multiple antennas 38 and, in particular, at least two UWB antennas 42 and 44 to communicate with the antenna 96 of the probe 94. The UWB antennas 42 and 44 may be configured as described above (e.g., omnidirectional antennas, directional sector antennas, transmitter, receiver, etc.). Similar to above, communication between the probe 94 and imager system 12 is configured to occur via the antenna 38 with the strongest signal strength (e.g., UWB antenna 42 or 44). The imager system 12 also includes control circuitry 74 configured to sends signals to the probe 94 and to acquire ultrasound information from the probe 94. Further, in certain embodiments, the control circuitry 74 is linked to switching circuitry 90. The switching circuitry 90 is configured to switch to UWB antenna 42 or 44 with the strongest signal strength among the at least two UWB antennas 42 and 44 to wirelessly communicate with the probe 94. The switching circuitry 90 may be configured and operated as described above in the radiological imaging systems.

The control circuitry 74 is configured to process the acquired ultrasound information (i.e., RF signal data or IQ data pairs) and to prepare frames of ultrasound information for display on a display system 98. The control circuitry 74 may be adapted to perform one or more processing operations according to a plurality of selectable ultrasound modalities on the acquired ultrasound information. Acquired ultrasound information may be processed in real-time during a scanning session as the echo signals are received. Additionally or alternatively, the ultrasound information may be stored temporarily in the RF/IQ buffer during a scanning session and processed in less than real-time in a live or off-line operation.

A user interface 100 may be used to control operation of the ultrasound system 10. The user interface 100 may be any suitable device for receiving user inputs to control, for example, the type of scan or type of transducer to be used in a scan. As such, the user interface 100 may include a keyboard, mouse, and/or touch screen.

The ultrasound system 10 may continuously acquire ultrasound information at a desired frame rate, such as at rates exceeding fifty frames per second, which is the approximate perception rate of the human eye. The acquired ultrasound information may be displayed on the display system 98 at a slower frame-rate. An image buffer 102 may be included for storing processed frames of acquired ultrasound information that are not scheduled to be displayed immediately. In one embodiment, the image buffer 102 is of sufficient capacity to store at least several seconds of frames of ultrasound information. The frames of ultrasound information may be stored in a manner to facilitate retrieval thereof according to their order or time of acquisition. The image buffer 102 may comprise any known data storage medium.

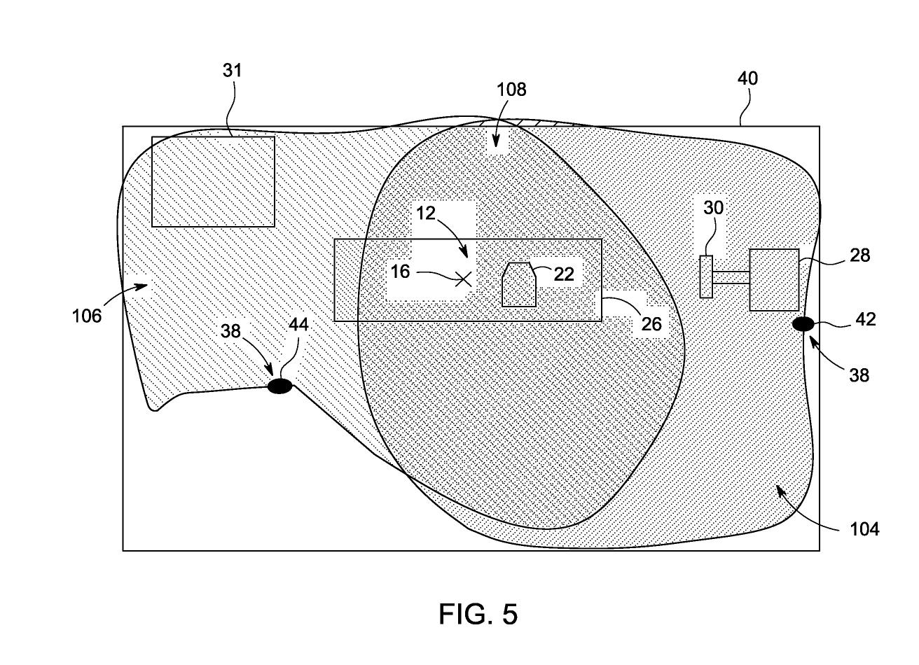

As mentioned above, the placement of the UWB antennas 42 and 44 either within the room 40 of the fixed X-ray system 10 or on components of the imager system 12 helps enable a higher rate of data exchange between the detector 22 and the imager system 12, to increase signal gain, and to increase wireless reception. FIG. 5 illustrates UWB wireless coverage within the room 40 of the fixed X-ray system 10. The room 40 includes the systems cabinet 31, table 26, and wall stand 28 with receiving structure 30 as described above in FIG. 1. The detector 22 is located on the table 26 and the position of the X-ray source 16 is indicated by the X. As illustrated, the UWB antennas 42 and 44 are positioned throughout the room 40 to maximize the UWB wireless coverage between the antennas 42 and 44. In certain embodiments, more than two UWB antennas 42 and 44 may be positioned throughout the room 40. Further, the UWB antennas may be disposed on components of the imager system 12 (e.g., wall stand 28 or systems cabinet 31). As mentioned above, placement of the UWB antennas 42 and 44 may take into account factors such as antenna polarization, proximity to large metal objects or reflectors, cable routing, and human body loading.

As illustrated, the UWB antennas 42 and 44 are positioned within the room 40 to provide complementary antenna patterns and to enable communication between the detector 22 and the UWB antenna 42 or 44 with the strongest signal strength. The UWB antenna 42 has a first area of coverage 104 and the UWB antenna 44 has a second area of coverage 106. The first and second areas of coverage 104 and 106 overlap within in the room 40 in area 108. The first and second areas of coverage 104 and 106 may each span 30 to 70 percent of the room 40. Together first and second areas of coverage 104 and 106 provided by the UWB antennas 42 and 44 span most of the room 40 (e.g., 80 to 100 percent of the room 40). This enables the imager system 12 to utilize the UWB antenna 42 or 44 with the strongest signal (e.g., by switching between the antennas 42 and 44) to communicate with the detector 22 as described above. A different UWB antenna 42 or 44 may be used when the detector 22 is utilized on the table 26 as opposed to when the detector 22 is utilized in conjunction with the wall stand 28 and receiving structure 30 depending on the signal strength of the antennas 42 and 44.

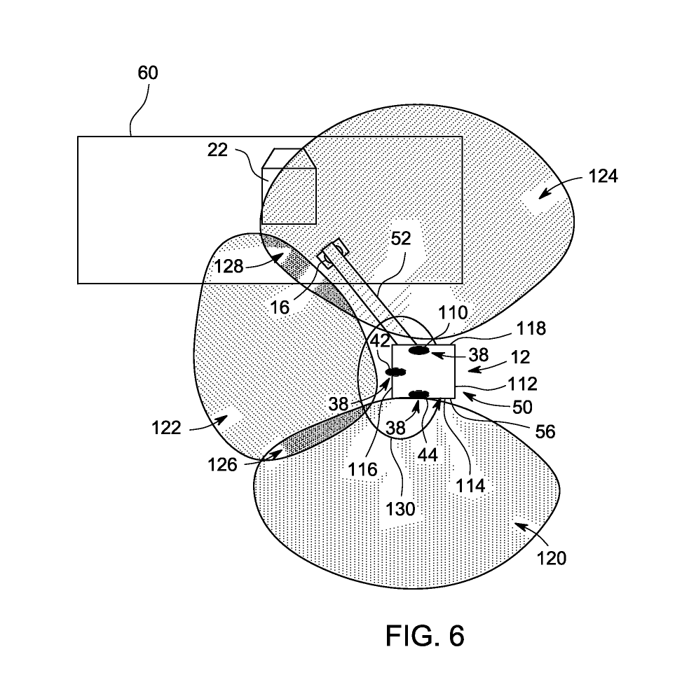

FIG. 6 illustrates the UWB wireless coverage with respect to the mobile X-ray system 10. As above, the placement of the UWB antennas 42, 44, and 110 within and/or on components of the imager system 12 helps enable a higher rate of data exchange between the detector 22 and the imager system 12, to increase signal gain, and to increase wireless reception. The mobile X-ray base station 50 is as described above in FIG. 2. As illustrated, the base unit 56 of the X-ray base station 50 includes sides 112, 114, 116, and 118. The handle 64 and support column 54 (described above and not shown) are respectively located at sides 112 and 116. As illustrated, the support arm 52 has been rotated from side 116 towards side 118 to place the source 16 over the bed 60. The UWB antennas 42, 44, and 110 are located within the base unit 56 adjacent sides 114, 116, and 118, respectively. As illustrated, UWB antennas 44 and 110 are located on opposite sides of the X-ray base station 50 (i.e., base unit 56 of the mobile imager). As mentioned above, placement of the UWB antennas 42, 44, and 110 may take into account factors such as antenna polarization, proximity to large metal objects or reflectors, cable routing, human body loading, and dynamic positioning as the imager system 12 moves around. For example, the UWB antennas 42, 44, and 110 are positioned within the base unit 56 of the mobile X-ray base station 50 to avoid shielding of wireless signals transmitted and received by the UWB antennas 42, 44, and 110. In particular, the UWB antennas 42, 44, and 110 are positioned within the base unit 56 of the X-ray base station 50 to avoid coverage of the antennas 42, 44, and 110 by metal that shields the transmittal and reception of wireless signals.

As illustrated, the UWB antennas 42, 44, and 110 are positioned within the imager system 12 (e.g., base unit 56) to provide complementary antenna patterns and to enable communication between the detector 22 and the UWB antenna 42, 44, or 110 with the strongest signal strength. UWB antenna 44 has a first area of coverage 120 emanating from side 114, UWB antenna 42 has a second area of coverage 122 emanating from side 116, and UWB antenna 110 has a third area of coverage 124 emanating from side 118. The first and second areas of coverage 120 and 122 overlap in area 126, and the second and third areas of coverage 122 and 124 overlap in area 128. Together the first, second, and third areas of coverage 120, 122, and 124 provided by the UWB antennas 44, 42, and 110, respectively, provide at least 270 degrees of coverage 130 around the X-ray base station 50 (e.g., sides 114, 116, and 118). This enables the imager system 12 to utilize the UWB antenna 42, 44, or 110 with the strongest signal (e.g., by switching between the antennas 42, 44, and 110) to communicate with the detector 22 as described above. A different UWB antenna 42, 44, or 110 may be used depending on the orientation of the base unit 56 with respect to the detector 22 on the bed 60. As illustrated, UWB antenna 110 may be utilized since side 118 is nearest the bed 60 and detector 22.

Technical effects of the embodiments include providing systems that provide medical imaging systems 10 with a wireless communication system using UWB communication configured to improve signal quality and to increase the data rate exchange between components of the medical imaging systems 10 (e.g., imager system 12 with either detector 22 or ultrasound probe 94). In fixed imaging systems, at least two UWB antennas 42, 44, and 110 may be disposed throughout the room 40 and/or on components of the imager system 12 to provide coverage over most of the room 40. In mobile imaging systems, at least two UWB antennas 42, 44, and 110 may be disposed within and/or on components of the imager system 12 to provide at least 270 degrees of coverage around the mobile imager 50. The imager system 12 is configured to communicate with the detector 22 or ultrasound probe 94 via the UWB antenna 42, 44, or 110 with the strongest signal. To enable communication between the UWB antenna 42, 44, or 110 with the strongest signal and the detector 22 or ultrasound probe 94, the imager system 12 may include switching circuitry 90 to switch between the antennas 42, 44, and 110. In addition, the UWB antennas 42, 44, and 110 may act as both a transmitter and receiver. Alternatively, the UWB antennas 42, 44, and 110 may include an least one antenna 42, 44, or 110 that acts solely as a receiver (e.g., high gain receiver) and at least one antenna 42, 44, or 110 that acts solely as a transmitter (e.g., low gain transmitter) to improve reception sensitivity. The design of the wireless communication system is configured to provide a simple, low cost system to increase signal gain and wireless reception.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A medical imaging system, comprising:
a mobile imager including a source of X-ray radiation and at least two antennas for wireless communication; and
a digital X-ray detector configured to receive X-ray radiation from the source, wherein the digital X-ray detector includes at least one antenna to communicate wirelessly with the mobile imager.

2. The system of claim 1, wherein the mobile imager is configured to wirelessly communicate with the digital X-ray detector via an antenna with the strongest signal strength among the at least two antennas.

3. The system of claim 2, wherein the mobile imager comprises switching circuitry configured to switch to the antenna with the strongest signal strength among the at least two antennas to wirelessly communicate with the digital X-ray detector.

4. The system of claim 1, wherein the at least two antennas comprise ultra wideband antennas.

5. The system of claim 1, wherein the at least two antennas comprise omnidirectional antennas.

6. The system of claim 1, wherein the at least two antennas comprise at least one omnidirectional antenna and at least one directional sector antenna.

7. The system of claim 1, wherein the at least two antennas comprise at least one transmitter and at least one receiver.

8. The system of claim 7, wherein the at least one receiver has a higher gain than the at least one transmitter.

9. The system of claim 1, wherein the at least two antennas are located on opposite sides of the mobile imager.

10. The system of claim 1, wherein the at least two antennas are located within the mobile imager to avoid shielding of wireless signals transmitted and received by the at least two antennas.

11. The system of claim 10, wherein the at least two antennas are located within the mobile imager to avoid coverage by metal.

12. The system of claim 1, wherein the at least two antennas are configured to provide at least 270 degrees of coverage around the mobile imager.

13. A medical imaging system, comprising:
an imager system including a source of X-ray radiation and at least two antennas for wireless communication; and
a digital X-ray detector configured to receive X-ray radiation from the source, wherein the digital X-ray detector includes at least one antenna to communicate wirelessly with the imager system.

14. The system of claim 13, wherein the imager system comprises a mobile imager.

15. The system of claim 13, wherein the imager system comprises a fixed imager system disposed within a room.

16. The system of claim 15, wherein placement of each antenna of the at least two antenna is configured to provide coverage throughout most of the room.

17. The system of claim 13, wherein the imager system is configured to wirelessly communicate with the digital X-ray detector via an antenna with the strongest signal strength among the at least two antennas.

18. The system of claim 17, wherein the imager system comprises switching circuitry configured to switch to the antenna with the strongest signal strength among the at least two antennas to wirelessly communicate with the digital X-ray detector.

19. The system of claim 13, wherein the at least two antennas comprise ultra wideband antennas.

20. The system of claim 13, wherein the at least two antennas comprise omnidirectional antennas.

21. The system of claim 13, wherein the at least two antennas comprise at least one omnidirectional antenna and at least one directional sector antenna.

22. The system of claim 13, wherein the at least two antennas comprise at least one transmitter and at least one receiver, and the at least one receiver has a higher gain than the at least one transmitter.

23. A medical imaging system, comprising:
an imager system including at least two ultra wideband antennas for wireless communication with a different component of the medical imaging system, wherein the different component includes at least one antenna to communicate wirelessly with the imager system, and the imager system is configured to wirelessly communicate with the different component via an antenna with the strongest signal strength among the at least two antennas.

24. The system of claim 23, wherein the different component of the medical imaging system comprises a digital X-ray detector.

25. The system of claim 23, wherein the different component of the medical imaging system comprises an ultrasound probe.
